(19) United States
(12) Patent Application Publication
(10) Pub. No.: US 2008/0006267 A1
(43) Pub. Date: Jan. 10, 2008

(54) Method and device for treating bruxism while sleeping

(76) Inventor: Joseph Cahill, Colinas de San Javier (MX)

Correspondence Address: LAW OFFICE OF ALAN W. CANNON, 942 MESA OAK COURT, SUNNYVALE, CA, 94086, US

(21) Appl. No.: 11/481,748

(22) Filed: Jul. 5, 2006

(51) Int. Cl. A62B 18/02

(52) U.S. Cl. 128/201.18

(57) ABSTRACT

Methods, devices and kits for treating bruxism while sleeping. The nostrils of a nose of a patient are blocked, thereby preventing the patient from breathing through the nostrils. The patient is then allowed to sleep, while the nostrils remain blocked, whereby the patient is forced to breathe through the mouth.

### FIELD OF THE INVENTION

The present application relates to treatments of medical conditions and devices for performing such treatments. More particularly, the present methods and devices relate to treatments of medical conditions including temporomandibular joint disorder (TMD) and/or grinding of teeth at night.

### BACKGROUND OF THE INVENTION

Temporomandibular joint disorder or TMD (sometimes referred to as “TMJ” or “TMJ disorder”) refers to a medical condition involving problems with the jaws and their functioning, and particularly problems with the temporomandibular joint. The temporomandibular system consists of the temporomandibular joint) TMJ 1 (illustrated in the partially cutaway view of FIG. 1), the teeth, and the neuromuscular system.

The TMJ 1 are the joints that allow the lower jaw (mandible) to move relative to the upper jaw (maxilla), and there are a pair of TMJ's one on each side of the jaws. A cartilage disk (not shown) resides between the bone of the mandible and the skull where each TMJ is formed. The teeth function in combination with the TMJ's during articulation of the mandible and act as a third contact location between the mandible and maxilla.

The neuromuscular system includes the nerves and muscles that operate to move the mandible via the TMJ's 1 to close and open the mouth. The neuromuscular system thus functions to provide the driving force for opening and closing the mandible relative to the maxilla. The nerves transmit the messages for the muscles to move the jaw, and also transmit pain signals when there is a problem with the function of the temporomandibular system. The muscles that perform the operation are fairly large, and include the masseter 2 that provides a lot of the strength for chewing.

Symptoms that are experienced by a patient having TMD can be numerous, including: pain and/or stiffness in one or both TMJ's 1, headaches in the temple region of the head, migraine headaches, toothaches, wearing of the teeth, broken or cracked teeth, sensitive teeth, difficulty opening the mandible, pain during chewing, particularly with hard or tough food, “popping”, grinding, or other unusual noise coming from the location of one or both TMJ's during closing and/or opening of the mandible, and/or neck pain, particularly in the neck muscles.

One of the recognized causes of TMD is bruxism, which refers to a nonfunctional grinding and clenching of the teeth. Patients may subconsciously practice bruxism while awake, but typically bruxism is performed while sleeping. Although bruxism can occur in varying degrees in severity, it can become so severe that the enamel can be ground from the teeth and/or cracking of one or more teeth can occur. One result of bruxing during sleep can be fatigue of the muscles in the neuromuscular system, particular the masseter, as the muscles of the neuromuscular system work fairly continuously during bruxism, which can occur for significant lengths of time during the night while sleeping. Most people grind their teeth while sleeping to some degree. For whatever reason some people do this very hard to the point where they wear the enamel from their teeth. This bruxing is done by the jaw muscles and by the morning they can be painful due to fatigue an inflammation of these muscles. This constant pressure also can damage the TMJs' articulating surfaces over time. The associated inflammation may also affect underlying nerves and vessels that reside near each temporomandibular joint. These nerves innervate the entire face, including the mouth and its contents, and their involvement may lead to any of the above state symptoms. Bruxism is the most common factor found in TMD.

Typically, custom formed mouth guards are prescribed for addressing bruxism. While this addresses the issue of wearing or cracking of the enamel of the teeth, as the mouth guard guards against tooth-tooth grinding, it does not prevent the grinding etiology of the bruxism or the other problems that may result therefrom, such as jaw muscle fatigue and TMD. Thus, there remains a need for preventing bruxism in a patient, particularly at night, while sleeping.

### SUMMARY OF THE INVENTION

A method of treating bruxism in a patient while the patient sleeps is provided. The nostrils of the nose of the patient are blocked, thereby preventing the patient from breathing through the nostrils. The patient is then allowed to sleep, while the nostrils remain blocked, whereby the patient is forced to breathe through the mouth.

Blocking of the nostrils may be performed by applying a clip over the nose, wherein the clip has first and second arm portions, and wherein free ends of said first and second arm portions are resiliently biased toward one another, so that when the free ends are placed over the nose, the free end portions compress the nose together to close off the nostrils.

A device for treatment of bruxism during sleeping is provided, wherein the device includes: a clip configured to be clamped over a nose of a patient, and a strap extending from the clip. The clip has first and second arm portions, wherein free ends of the first and second arm portions are resiliently biased toward one another, so that when the free ends are placed over the nose, the free end portions compress the nose together to close off the nostrils, thereby preventing the patient from breathing through the nose. The strap has first and second ends connected to the first and second arm portions of the clip and has a length such that when the strap is looped around the back of the head or neck of the patient when the clip is positioned over the nose to close off the nostrils, no slack exists in the strap.

A kit for treatment of bruxism while sleeping, is provided, including a clip configured to be clamped over a nose of a patient, said clip having first and second arm portions, wherein free ends of said first and second arm portions are resiliently biased toward one another, so that when the free ends are placed over the nose, the free end portions compress the nose together to close off the nostrils; and instructions for using the clip to treat bruxism during sleeping, including blocking the nostrils of the nose of the patient by applying the clip thereover, thereby preventing the patient from breathing through the nose, and then going to sleep, while the nostrils remain blocked, whereby the patient is forced to breathe through the mouth.

These and other advantages and features of the invention will become apparent to those persons skilled in the art upon reading the details of the methods, devices and kits as more fully described below.

### BRIEF DESCRIPTION OF THE DRAWINGS

FIG. 1 is a cutaway illustration of the head of a patient showing a temporomandibular joint and masseter muscle.

FIG. 2 illustrates a device according to the present invention that is properly installed for treating bruxism while sleeping.

FIG. 3 illustrates the device of FIG. 2 being used during sleeping by a patient.

FIG. 4 illustrates a strap length adjustment mechanism that may optionally be provided.

FIG. 5 illustrates a device according to an embodiment having cushioning members or pads.

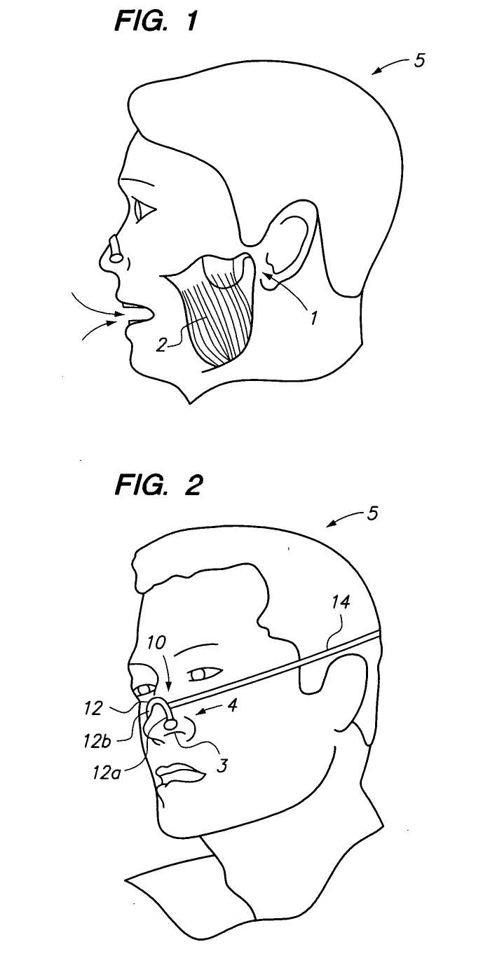

### DETAILED DESCRIPTION OF THE INVENTION

Before the present methods and devices are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a strap” includes a plurality of such straps and reference to “the joint” includes reference to one or more joints and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The present invention provides devices and methods of treating TMD and preventing bruxism. The device provided herein are inexpensive and do not require special fitting. The devices described herein do not need to be disinfected or cleaned regularly. The present devices and methods prevent the action of teeth grinding by the constant tensing of the mastication muscles during sleeping, thereby disrupting the patient's abnormal physiological function. Such treatment not only prevents bruxism, but only also prevents more complicated, costly and painful surgery that may be required after years of teeth grinding and development of TMD and/or cracked or broken teeth.

FIG. 2 illustrates a device 10 having been installed on a patient 5 in position to prevent bruxism during sleeping. Device 10 includes clip 12 that may be U-Shaped or V-shaped, wherein the arms or legs 12a, 12b of clip 12 are resiliently biased towards one another when placed over the nose of a patient, so that the legs 12a, 12b compress the nostrils of the patient, thereby closing them off to air flow. Clip 12 may be formed from spring steel, nickel-titanium alloy, resilient polymer or other material that, when formed in a U-shape or V-Shape can be set to form a predetermined distance between the ends of the legs of the U-shape or V-shape, and wherein the legs can be deflected apart from the set positions. Upon release of the forces to deflect the legs apart, the legs resiliently return to their original positions where they are separated by the predetermined distance.

At least the free ends of the legs 12a, 12b, and up to all of clip 12 can further be coated with an elastomer, to make the clip atraumatic in areas where it contacts the skin of the patient, and also to increase friction at the contact points with the skin to facilitate maintaining the clip in the desired location of placement on the patient.

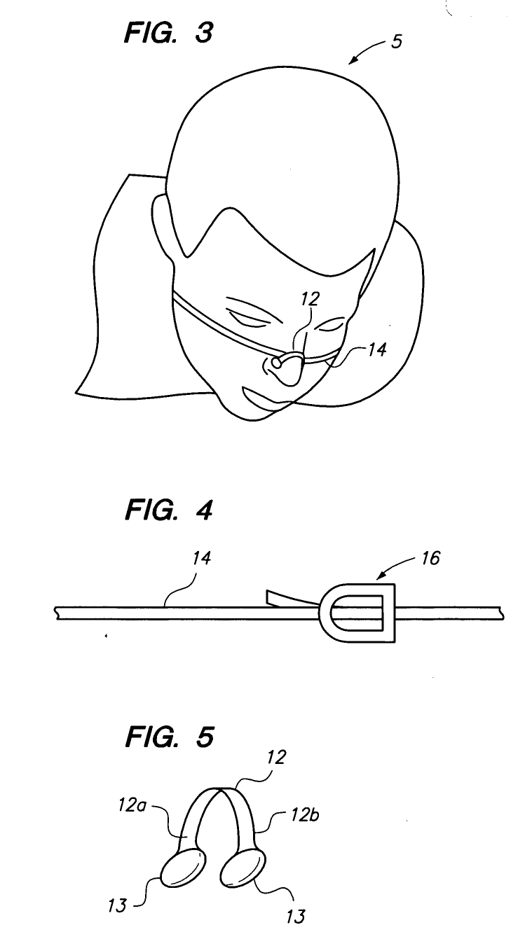

An elastic strap 14 may also extend from clip 12, with opposite ends of strap 14 being connected to, integral with or fixed to opposite legs 12a, 12b of clip 12. Thus, strap 14 is configured to loop around the back of the head or neck of the patient 5 during use, as illustrated in FIGS. 2 and 3, respectively. Strap 14 is of a length that, when clip is positioned as intended on the nose of the patient 5 and strap 14 loops around the head or neck of the wearer, strap 14 is slightly elastically deformed so as to provide a retention force to clip 12 to prevent it sliding off the end of the nose of the patient 5. The slight pulling against the broader portion of the nose that is closer to the rest of the face, acts to anchor clip 12 in the desired position. Alternatively, strap 14 may be provided to contact against the neck or back of the head, without elastic deformation, but with no slack, so that forward movement of clip 12 would elastically deform strap 14 generating an elastic force to pull clip 12 back into the desired location of original placement. The length of strap 14 may be adjustable by the provision of one or more buckles 16 (FIG. 4) or other adjusting mechanism.

Device 10 as described can be used in a method to prevent bruxism while a patient sleeps. By preventing air flow through the nostrils 3 of the patient 5, the patient 5 is forced to breathe through the mouth via an unconscious, reflex mechanism. The requirement to breathe through the mouth during sleeping also requires that the mouth be at least somewhat open, at least to the extent where the upper and lower teeth are not in contact. Also, an opposing set of muscles must be used to open the mouth/separate the jaws, and this also requires relaxation of the masseter and any muscles used to close the jaws and grind the teeth. By relieving the constant tension and activity on the muscles of mastication, particularly the masseter muscles, this technique reduces inflammation and, as a consequence, reduces symptoms directly or indirectly caused by such inflammation. Thus, by making it not possible to breathe through the nostrils, the patient is forced to breathe through the mouth. Even if the patient has the physiological pattern of grinding teeth during sleeping, by requiring the patient to breathe through the mouth, this physically and safely prevents the patient from being able to grind his/her teeth.

To treat a patient for bruxism, clip 12 is applied over the nose 4 of the patient 5 as illustrated in FIG. 2, so that the free ends of arms 12a,12b are positioned over the nostrils 3 to close the nostrils off, thereby preventing air flow through them. Strap 14 may be looped around the back of the head or neck of the patient, either under slight tension, or at least to have no slack, so that clip 12 is held in the correct position over the nose 4, as clip 12 cannot slide forward off of the nostrils, and the connected portions of the arms 12a,12b are drawn against the bridge of the nose to anchor clip 12 in the desired location.

After determining that the patient 5 can only breathe through the mouth, the patient 5 is allowed to sleep. As the patient sleeps, the masseter and other muscles used to bite down and masticate are maintained relatively relaxed, and the teeth are prevented from grinding against one another by the requirement of the patient to breathe through the nose and thus keep the upper and lower sets of teeth from being held under compression.

With the arrangement shown in FIGS. 2-3, the patient 5 is free to roll over during sleeping without dislodging clip 12, so that mouth breathing enforcement is maintained. When the patient wakes up and is finished sleeping for that session, device 10 is removed and stored to be accessed and reinstalled the next time that the patient is ready to sleep.

The free ends of arms 12a,12b may optionally be provided with cushioning members or pads 13 as illustrated in FIG. 5, which may be constructed of felt, cotton or other materials that are non-irritating upon prolonged contact with the skin. Pads 13 provide further comfort to the user as the compression forces applied by the free ends of arms 12a,12b are distributed over the surfaces of the pads 13 making them even more atraumatic.

Not only is a treatment device according to the present invention simple and inexpensive, it is also easy to apply, so that a patient can perform treatments without any additional medical assistance after an initial instructional training session.

Instructions may be provided with a device 10 as described, to assist in the initial instructional training for treatment of bruxism while sleeping. The instructions may include the steps required for proper use of device 10 during sleeping. Additionally, the instructions may include a description of the etiology of bruxism and the mechanism for preventing bruxism that is actuated by proper use of the device. Cleaning and care instructions may also be provided.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method of treating bruxism in a patient while the patient sleeps, said method comprising the steps of:
blocking the nostrils of the nose of the patient, thereby preventing the patient from breathing through the nostrils; and
sleeping while the nostrils remain blocked, whereby the patient is forced to breathe through the mouth.

2. The method of claim 1, wherein said blocking comprises applying a clip over the nose, said clip having first and second arm portions, wherein free ends of said first and second arm portions are resiliently biased toward one another, so that when said free ends are placed over the nose, said free end portions compress the nose together to close off the nostrils.

3. The method of claim 2, further comprising looping a strap around the back of the head or neck of the patient, wherein the strap is connected to said first and second arm portions; and
maintaining the strap in contact against the back of the head or neck to maintain positioning of said clip.

4. The method of claim 3, wherein said strap is elastic and is maintained is slight elastic deformation against the head or neck.

5. The method of claim 3, wherein said strap is maintained free of slack, so that movement of said clip forward on the nose is prevented.

6. The method of claim 5, wherein said strap is elastic.

7. A device for treatment of bruxism during sleeping, said device comprising:
a clip configured to be clamped over a nose of a patient, said clip having first and second arm portions, wherein free ends of said first and second arm portions are resiliently biased toward one another, so that when said free ends are placed over the nose, said free end portions compress the nose together to close off the nostrils; and
a strap having first and second ends connected to said first and second arm portions, said strap having a length such that when said strap is looped around the back of the head or neck of the patient when said clip is positioned over the nose to close off the nostrils, no slack exists in said strap.

8. The device of claim 7, wherein when said strap is looped around the back of the head or neck of the patient when said clip is positioned over the nose to close off the nostrils, said strap is elastically deformed under slight tension.

9. The device of claim 7, further comprising a pad mounted at said free ends of each of said first and second end portions.

10. A kit for treatment of bruxism while sleeping, said kit comprising:
a clip configured to be clamped over a nose of a patient, said clip having first and second arm portions, wherein free ends of said first and second arm portions are resiliently biased toward one another, so that when said free ends are placed over the nose, said free end portions compress the nose together to close off the nostrils; and
instructions for carrying out the method of claim 1.

11. The kit of claim 10, further comprising a strap having first and second ends connected to said first and second arm portions, said strap having a length such that when said strap is looped around the back of the head or neck of the patient when said clip is positioned over the nose to close off the nostrils, no slack exists in said strap.

12. The kit of claim 11, wherein said strap is preconfigured with a length such that the strap maintains contact with no slack against the back of the head or neck of the patient when said clip is positioned over the nose to close off the nostrils.

13. The kit of claim 10, further comprising a description of the etiology of bruxism and the mechanism for preventing bruxism that is actuated by proper use of said device.
